(19) United States
(12) Patent Application Publication
(10) Pub. No.: US 2003/0126043 A1
(43) Pub. Date: Jul. 3, 2003

(54) Management of decentralized production and centralized material distribution

(76) Inventors: Cheng-Ju Chen, Taipei (TW); Yi-Ming Liao, Taipei (TW); Yun-Chi Lee, Taipei (TW)

Correspondence Address: BIRCH STEWART KOLASCH & BIRCH, PO BOX 747, FALLS CHURCH, VA, 22040-0747, US

(21) Appl. No.: 10/033,986

(22) Filed: Jan. 3, 2002

(51) Int. Cl. G06F 17/60

(52) U.S. Cl. 705/28

(57) ABSTRACT

A method for managing decentralized production and centralized materials distribution aims at resolving the problems of manually distributing materials by the Enterprise Resource Planning (ERP) server in the manufacturing industry. By using a Configure to Order (CTO) concept to transmit data on the network, the invention combines bills of material (BOM) to process centralized management and distribution of materials to reduce time needed in material delivery and enhance efficiency of production for factories.

### BACKGROUND OF THE INVENTION

1. Field of the Invention

This invention relates to a material distribution method, and particularly a method that is capable of managing production decentralization and material centralization on material management systems in the manufacturing industry.

2. Related Art

The current development of B2B e-commence is mainly focused on how to merchandise on the Internet. However, daily problems in the manufacturing industry include: what parts or components need to be purchased, how to plan production schedules after purchasing material items, how to arrange delivery of finished goods , how to manage excess/surplus stock, etc. For example, capacity forecast and formal orders are not the same thing, and even a formal order could possibly change without notice. Therefore, loss due to excess/surplus stock resulting from mistaken list making and incorrect material preparation often occurs. Conventional material issuing methods in an Enterprise Resource Planning (ERP) system mostly employ a lot-size issuing method. If a forecast order is far lower than an actual order in quantity, the Enterprise Resource Planning (ERP) system is unable to issue materials for production to satisfy production-planning requirements. Moreover, manually picking one-by-one from various material categories under the operation of material selection causes inaccuracy, duplicated inventory stock among factories, wasted resources, and much more time spendt in material distribution within factories, which greatly increases costs.

FIG. 1 is a schematic representation of presently known operations for distributing materials that illustrates problems in the process of material distribution as follows:

An enterprise end 10 owns various prototypes a˜n, which have their respective bills of material (BOM), including generally used (common) components and particular components, e.g. components for prototype A are provided by the supplier 50a, components for prototype B are provided by the supplier 50b, etc. Components from respective bills of material (BOM) of different prototypes are delivered to individual factories 100 a˜n for production. However, if there is any supplier unable to deliver materials on time, or a factory is short on components for production, there are problems in dispatching materials from other factories, so as to make the production lines idle while waiting for material deliveries, which also increases distribution costs.

Hence, management of decentralized production and centralized material distribution methods in the manufacturing industry has become a heavily focused subject.

### SUMMARY OF THE INVENTION

In view of the foregoing, the invention aims at resolving the preceding disadvantages to provide a method for managing production decentralization and material centralization. The primary objects of the invention are integrating multi-level bills of material (BOM) of parent/component parts by exploding all prototypes through an Enterprise Resource Planning (ERP) server of the enterprise end, and classifying material categories into customized tables and columns for easily decentralizing components to corresponding factories/manufactories for production to avoid wasting time in the process of distribution among factories/manufactories. This achieves the goal of managing centralized materials.

The disclosed method of managing decentralized production and centralized materials distribution according to the invention at least consists of: receiving at least one bill of material (BOM) from the suppliers through the Enterprise Resource Planning (ERP) server, integrating the bill of material (BOM) through the Enterprise Resource Planning (ERP), distributing materials to a specific factory through the Enterprise Resource Planning (ERP), purchasing materials through the material requirements planning server, and transferring data to the supplier end through a specified transmission format and method, so that the supplier end can deliver materials as contracted.

The foregoing, as well as additional objects, features and advantages of this invention will be more readily apparent from the following detailed description, which proceeds with reference to the accompanying drawings. Specific structures and functional details disclosed hereunder are not to be interpreted as limiting, but merely as a basis for the claims and as a representative basis for teaching one skilled in the art to variously employ the invention.

### BRIEF DESCRIPTION OF THE DRAWINGS

The invention will become more fully understood from the detailed description given hereinbelow. However, the following description is for purposes of illustration only, and thus is not limitative of the invention, wherein:

FIG. 1 is a schematic representation of presently known operations of materials distributing.

FIG. 2 is a schematic representation of managing decentralized productions and centralized materials distribution of the invention.

FIG. 3-a is a flowchart representation of managing decentralized production and centralized materials distribution according to the invention.

FIG. 3-b is a sub-flowchart representation of managing decentralized production and centralized materials distribution according to FIG. 3-a.

FIG. 4 is a systematic structure of data transmission according to the invention.

FIG. 5 is an exploded view of presently known bills of material (BOM) FIG. 6 is an exploded view of bills of material (BOM) according to the invention.

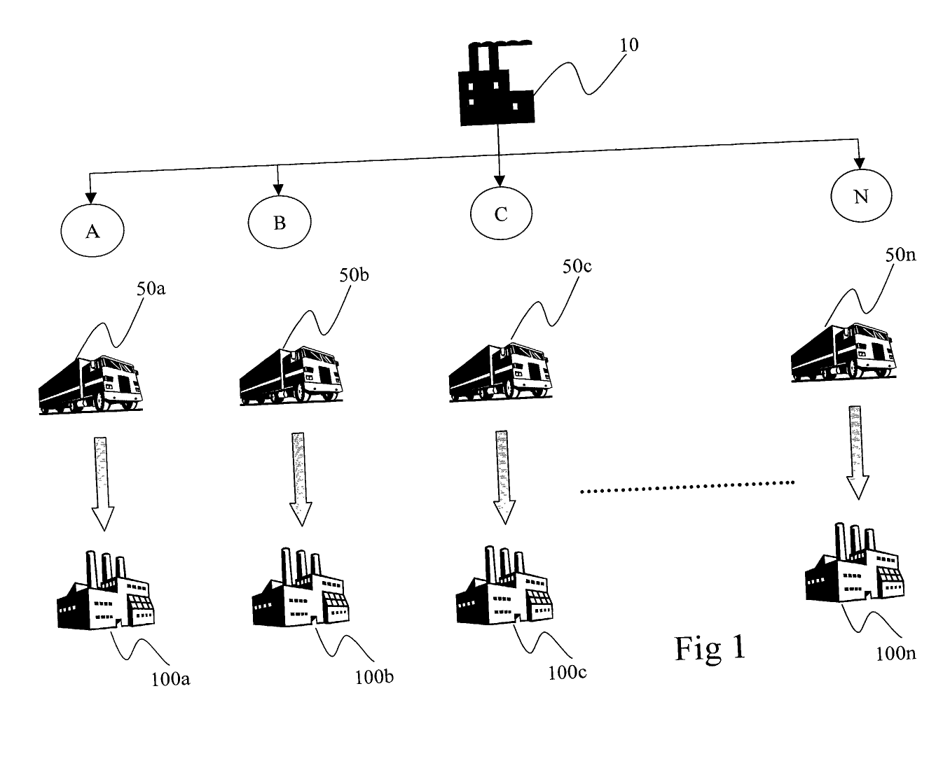

### DETAILED DESCRIPTION OF THE INVENTION

The invention proposes a method for managing decentralized production and centralized materials distribution. In particular, the method, based on the advocacy of the up-to-date Business Process Re-Engineer (BPR), mainly aims at improving effective utilization and management of enterprise resources and re-engineering processes of materials distribution and management to enhance efficiency and reduce operation costs of the organization. The invention pertains to a management method of decentralized production and centralized materials distribution to transmit data in a timely fashion for both operations of distribution and purchase of material items. Moreover, the invention pertains to the use of an Enterprise Resource Planning (ERP) server to control and integrate effective data, based on a specific data transmission method, initially giving functional definitions to different production lines to make all production lines perform well, so as to enhance efficiency.

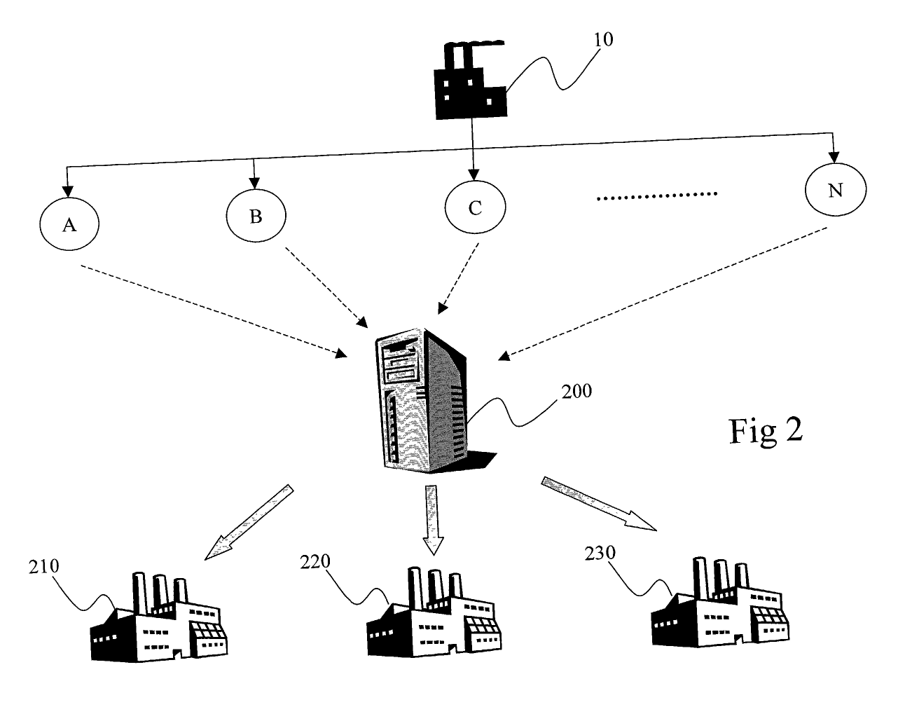

The feasibility and practicality of the invention will be elaborated by means of an embodiment depicted in the following. The disclosed method is capable of integrating materials of different prototypes through the systems to define material categories and to distribute materials to relevant production lines. FIG. 2 is a schematic representation of managing decentralized production and centralized materials distribution of the invention. Details are provided below.

Generally, an enterprise end 10 produces various prototypes to satisfy the requirements of all buyers. There are different bills of material (BOM) related to the respective prototypes a˜n, and exploding those bill of materials (BOM) is a real burden to general systems that reduces overall system efficiency. Therefore, the invention enables material items of all prototypes to be integrated by centralized management through the Enterprise Resource Planning (ERP) server 200, and to be distributed to different factories. There are 3 predefined categories of facilities according to the invention: the specific materials facility, the common materials facility, and the obsolete stock facility. Details are further provided as follows:

The specific materials facility 210, utilizing particular materials for production, manufactures specified components or parts needed for respective prototypes, among which there are no overlapping components or parts.

The common materials facility 220, which manages general materials for distribution, delivers common components or parts to required factories 100. These general materials relate to common components or parts needed for at least two prototypes, and are evaluated by a pre-set column through the Enterprise Resource Planning (ERP) server 200.

The obsolete stock facility 230, which manages materials that are out-of-date, centrally processes claims to the buyer who placed the order. These obsolete stocks relate to materials that are at the end of their life cycle, and are disposed of according to the regulations of the enterprise 10.

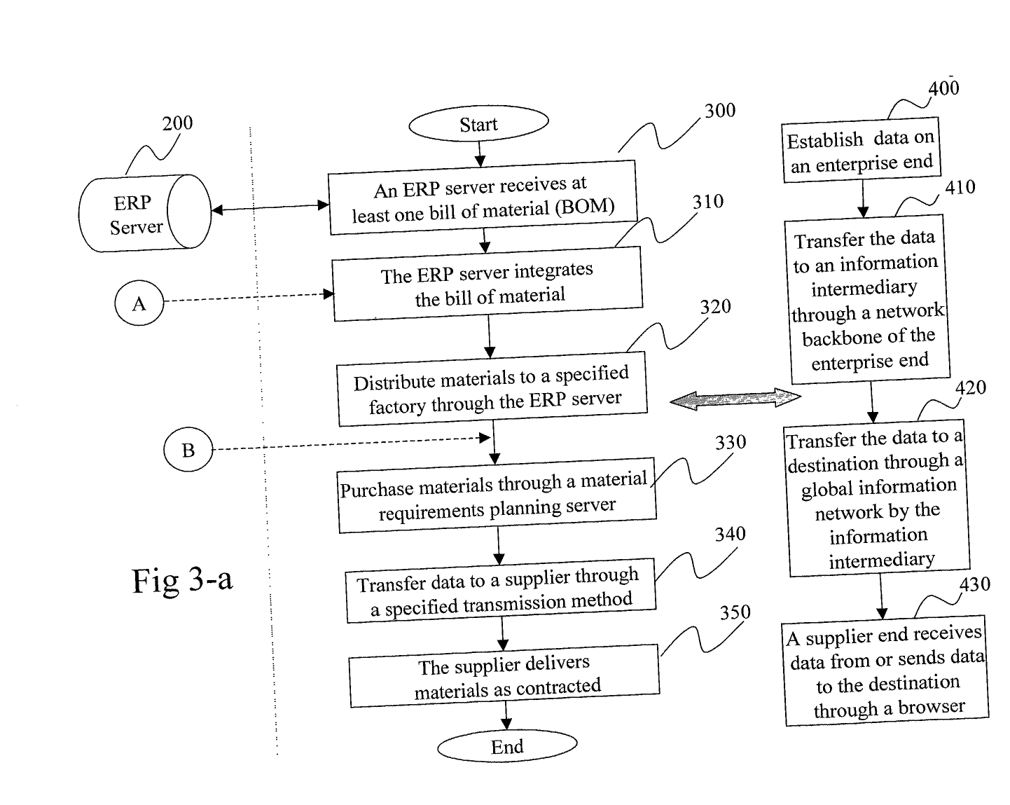

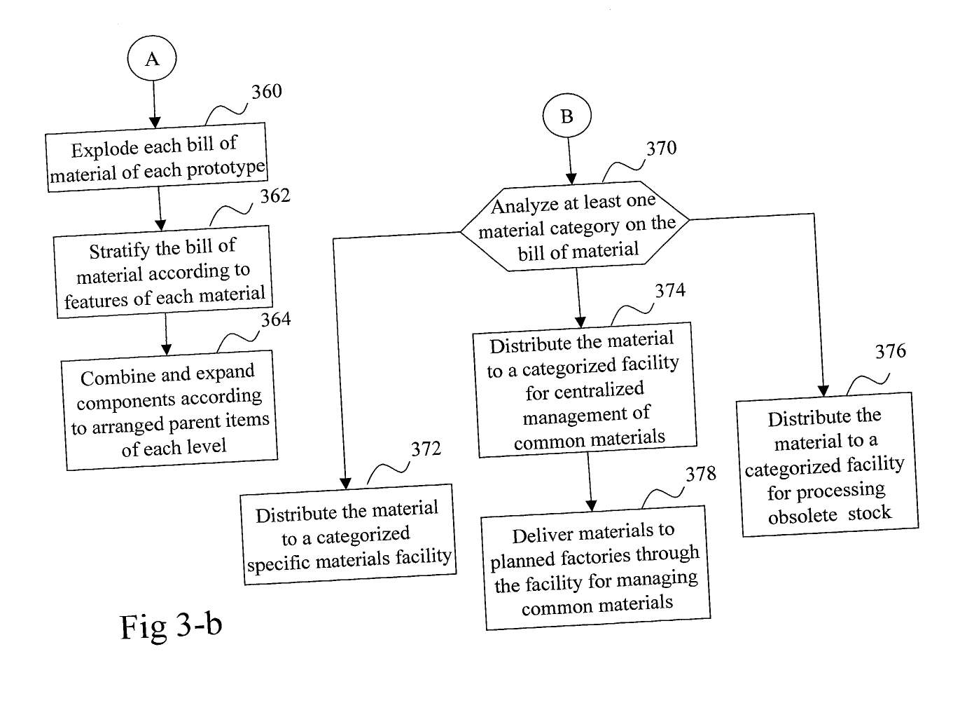

FIGS. 3, 3-a, and 3-b are schematic and flowchart representations of managing decentralized production and centralized materials distribution of the invention. They are described in detail below:

First, an Enterprise Resource Planning (ERP) server 200 receives at least one bill of material (BOM) (step 300). The bill of material (BOM) is integrated through the Enterprise Resource Planning (ERP) server 200 (step 310). Those who first operate the Enterprise Resource Planning (ERP) server 200 must go to process symbol A. Refer to process symbol A in FIG. 3-b. The Enterprise Resource Planning (ERP) server explodes all bills of material (BOM) of respective prototypes (step 360), stratifies the bill of material (BOM) according to the features of each material (step 362), and finally combines and expands the components or parts according to arranged parent items of each level (step 364). This is a method of exploding bills of material (BOM), which greatly accelerates the process of exploding bills of material (BOM), so that the Enterprise Resource Planning (ERP) server 200 is able to turn overlapping components or parts into common materials and turn the rest into specific materials. The Enterprise Resource Planning (ERP) server 200 then returns to the process of FIG. 3-a, after finishing material integration and storing data into a database. (Followed (step 310))—(I don't understand this-should this say “Following step 310 . . . ”?), the Enterprise Resource Planning (ERP) server 200 will distribute materials to a specified factory 100 (step 320), the process for which is noted by the process symbol B in FIG. 3-b.

The Enterprise Resource Planning (ERP) server 200 analyzes at least one material category on the bill of material (BOM) (step 370). The aforementioned materials are: specific materials, common materials and obsolete stock. If an analyzed item belongs to the specific materials category, then it is distributed to a specific materials facility for production (step 372). If an item belongs to the common materials category, then it is distributed to a categorized facility for centralized management (step 374). If an item belongs to the obsolete stock category, then it is delivered to a categorized facility for disposal (step 376). Therefore, the process symbol B in the FIG. 3-b is completed before returning to the rest of the process in FIG. 3-a.

In step 320 in FIG. 3-a materials are distributed to appropriate factories 100, and material purchase is processed through a material requirements planning server (step 330), which is provided by the Enterprise Resource Planning (ERP) server 200 to determine capability based on product orders placed by the buyers, to place purchase orders to the supplier end 50, and to transfer data to the supplier end 50 through a specified data transmission method (step 340). After receiving data, the supplier will deliver materials as contracted (step 350).

The above-mentioned specified data transmission method relates to the following process: first, establish data on an enterprise end 10 (step 400), which includes an enterprise front end server 540, an enterprise back end server 500 and a Supplier Chain Management (SCM) server 530. The data is stored on an ERP document connector server 525 to generate different required information through several Enterprise Resource Planning (ERP) servers 200. The enterprise end 10, therefore, transfers the data to an information intermediary through a network backbone 580 (step 410). The enterprise end 10 utilizes information generated by the Enterprise Resource Planning (ERP) server 200 based on a File Transfer Protocol (FTP), and the data is transferred to the information intermediary 560, who stores the data on a purchase database and transfers the data to a destination through a global information network (step 420) for suppliers to browse. One supplier 50 receives data from and sends data to a destination through a browser (step 430) so that the supplier end 50 delivers materials as contracted (step 440) to achieve the object of data transmission.

As the information intermediary 560 only provides a platform to the suppliers and enterprises for data transfer, the enterprise end 10, before transferring data to the information intermediary 560, has set up a data transfer split and a data transfer engine between the enterprise end 10 and the information intermediary 560. The data transfer engine is located in the data transfer split. When data are transferred to the information intermediary 560 through the data transfer split linked to a function library through the data transfer engine, the function library converts the data into required formats for different suppliers, so as to complete the transfer format process, and return (step 420) to proceed with the other remaining procedures. Hence, based on such a data format transfer method set forth above, different data formats can be customized to meet the requirements of different suppliers, to thereby achieve the object of transferring data formats in a configure-to-order fashion.

The disclosed method of the invention is to place conventional data transfer concepts and architecture on the Web. It mainly employs the techniques of Enterprise Resource Planning (ERP), Supply Chain Management (SCM) and Information Intermediary to achieve the function of integrating diverse data and transferring data in a timely fashion. It can be used between the suppliers and the enterprise end in the supply chain to enable the suppliers to actively receive data, and to directly transfer effective information according to users' requirements. In the mean time, it can also work in reverse by sending effective information from the suppliers to the enterprise end. It further establishes a data transfer unit at a third-party authentication organization between the supplier ends and the enterprise end to facilitate data transfer.

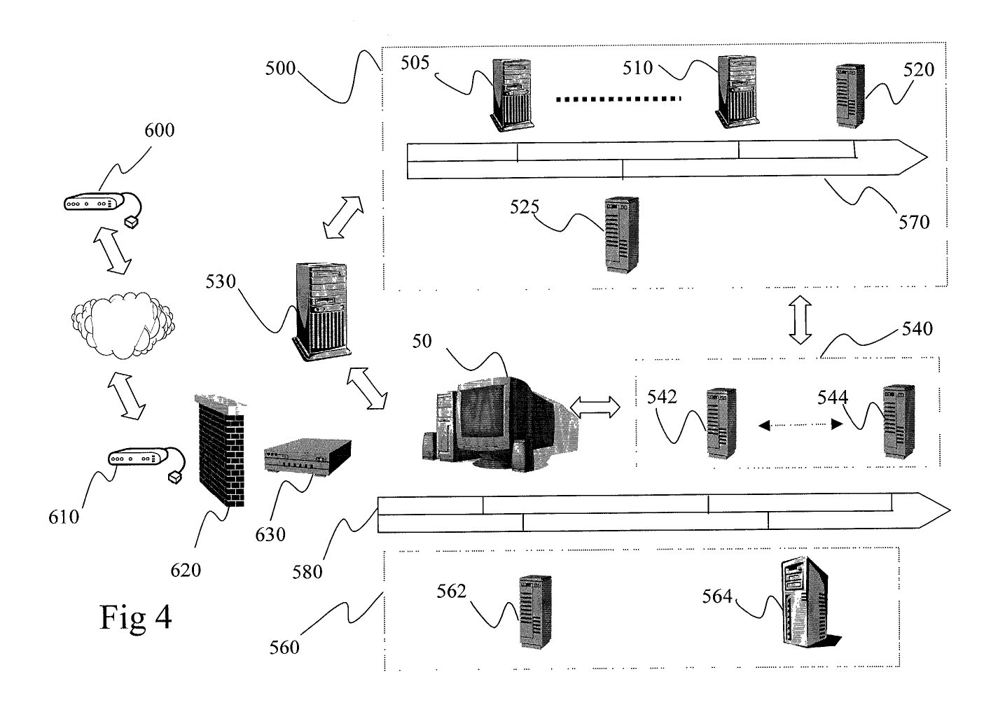

FIG. 4 illustrates the systematic structure of data transmission according to the invention. It comprises one modem 600 linking to another modem 610, which both may be dial-up modems, network (Local Area Network, LAN) modems, ISDN modems, cable modems or the like. It enables users to enter an enterprise internal network 570 through the identity authentication of a Firewall 620 and a Router 630, which is for linking two network facilities and converting data packets to data frames to select paths. The enterprise internal network 570 is linked to a supplier end 50 and an information intermediary 560. The enterprise internal network 570 consists of (1) an enterprise back end server 500, (2) a supply chain management (SCM) server 530, and (3) an enterprise front end server 540:

(1) The enterprise back end server 500 further includes: (a) a first end Enterprise Resource Planning (ERP) server 505, (b) a second end Enterprise Resource Planning (ERP) server 510, (c) an Enterprise Resource Planning (ERP) application server 520, and (d) an Enterprise Resource Planning (ERP) Document Connector Server 525. Their respective functions will be described as follows:

(a) The first end Enterprise Resource Planning (ERP) server 505, and (b) the second end Enterprise Resource Planning (ERP) server 510: the main function of both servers is to provide a base for the entire enterprise information system and to integrate the results. These servers integrate all operations of the enterprise, including human resources, finances, manufacturing, distribution, and communication between organizations, customers and suppliers, and assist in managing production processes and reengineering the processes.

(c) The Enterprise Resource Planning (ERP) application server 520: the main function of this server is to provide a plurality of defined fields and formats, and to store the data of the first end Enterprise Resource Planning (ERP) server 505 and the second end Enterprise Resource Planning (ERP) server 510, and also to provide a function that enables the supplier end 50 to select any of the defined fields and formats required, and allows the supplier end 50 to define its own fields and formats when in use, so as to enhance the portability of the Enterprise Resource Planning (ERP) application server. It also stores the fields and formats on the information intermediary 560, and enables the transmission of data back to the enterprise end 10 after data conversion.

(d) the ERP Document Connector Server 525: the main function of this server is to allow the data and documents of the first end Enterprise Resource Planning (ERP) server 505 and the second end Enterprise Resource Planning (ERP) server 510 to be stored in the Enterprise Resource Planning (ERP) application server 520 linking to each other, and to store the data and messages being sent back by the enterprise front end server 540, so that the system can easily analyze and abstract useful data during integration, and determine the final data storage location, or allow people in the enterprise to search and retrieve required information in the shortest possible amount of time.

The aforementioned servers (a), (b), (c) and (d) are linked to one another through an enterprise internal network (Local Area Network, LAN) 570. The LAN 570 can be an Ethernet.

(2) The supply chain management server 530: the main function of this server is to link the enterprise front end server 540, the enterprise back end server 500 and the supplier end 50 to one another, and to provide, in an electronic way and through supply chain management (SCM), planning and control of products, services, information and money transactions, so that the enterprise may get the right products at the right places at the minimum cost with minimum inventory and still can offer customers excellent service, thereby to utilize and distribute enterprise resources (such as people, equipment, materials, and capital) effectively and efficiently. The Supply Chain means a network consisting of assembled individual entities that execute the above-mentioned processes, and which transfer materials from the beginning to become finished products at the end and finally be delivered to customers.

(3) The enterprise front end server 540 consists of (a) an Active Data Warehouse (ADW) server 542 and (b) a Security Data Exchange Server 544, which are both described as follows:

(a) The ADW server 542: the main function of this server is to automatically capture data, which was input by the supplier end 50, from a purchase database 564 and temporarily store the data therein. After analyzing and integrating the data, the ADW server stores the captured data on the enterprise back end server 500. In the mean time, the ADW server actively captures data provided by the enterprise back end server 500 and temporarily stores it therein, It then stores the data on the information intermediary 560 after the data is analyzed and integrated.

(b) The Security Data Exchange Server 544: the main function of this server is to perform security authentication on the data and messages actively captured by the ADW server 542 before storing. That is why the ADW server 542 performs the temporarily storing process.

The supplier end 50 is a supplier that may input relative materials information through the Web site provided by the information intermediary 560.

The information intermediary 560 is a third-party authentication organization that does not belong to the suppliers or the enterprises. It provides a platform for storing data of the suppliers and enterprises, and offers added value network functions. The information intermediary 560 consists of (a) a Purchase Order Webquery server 562, and (b) a purchase database 564. These are described in detail as follows:

(a) The Purchase Order Webquery server 562: the main function of this server is to allow the supplier end 50 and enterprise end 10 to inquire about the progress of purchase order processing on the Web site provided by the information intermediary 560. All the data are directly accessed by the purchase order database 564.

(b) The purchase database 564: the main function of this database is to store the customized fields and formats generated by the Enterprise Resource Planning (ERP) application server 520 and actively captured by the ADW server 542 for the supplier end 50 to directly access the customized fields and formats from the database for data entry use. If the customized fields and formats cannot meet requirements, suppliers can directly modify the self-defined fields. Another function is to store the data into the purchase database 564 that are transferred from the enterprise end 10 and input by the supplier end 50.

The above-mentioned data transmission between the enterprise front server 540, the supplier end 50, and information intermediary 560 is transferred through a network backbone 580.

According to the above, functions and processes provided by the information intermediary 560 are in the same formats, so the information intermediary 560 is unable to provide flexible fields and formats for various suppliers to improve efficiency. Therefore, the disclosed invention aims at resolving such a problem by proposing a data transfer mode by using the configure to order (CTO) concept to complete data transmission on the network based on customized fields and formats, which enable the suppliers to order/deliver materials more efficiently and easily.

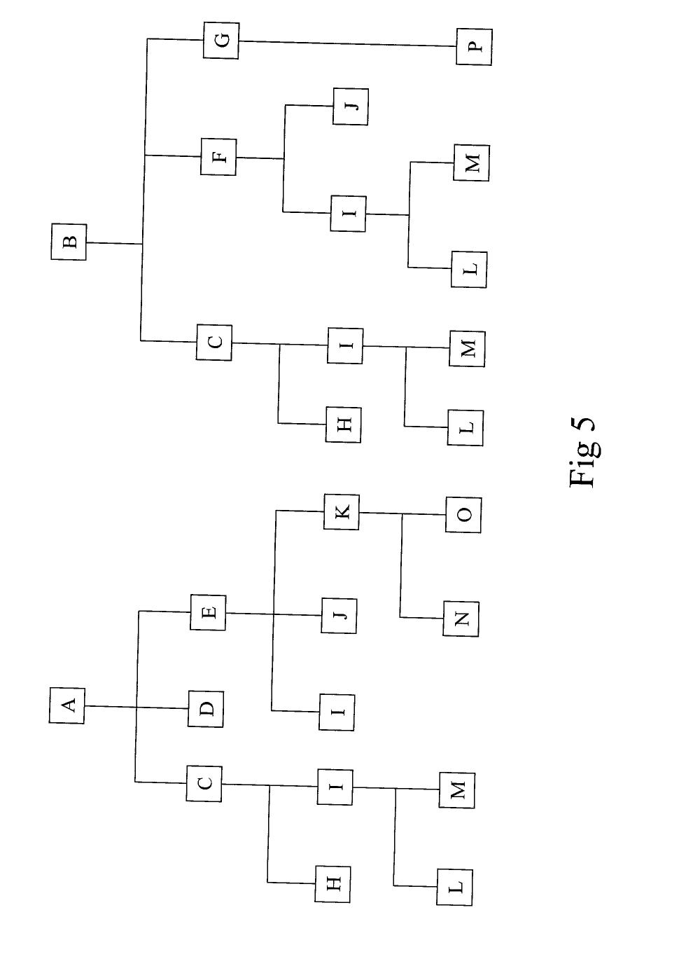

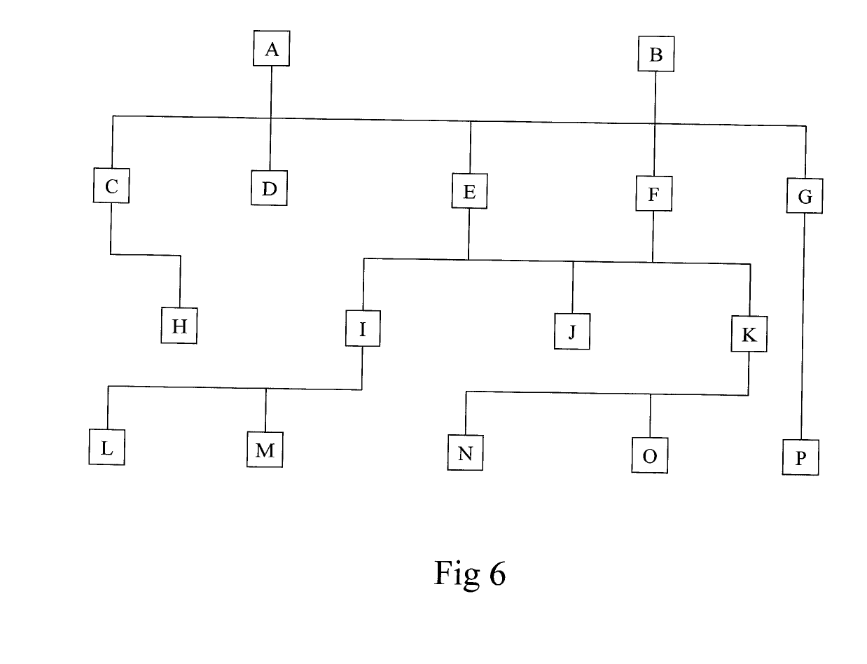

FIG. 5 is an exploded view of presently known bills of material (BOM) that illustrates the method of exploding bills of material (BOM).

First, the system explodes the first level of a bill of material (BOM) of prototype A (material modules C, D, and E), then explodes the second level (material modules H, I, I, J, and K). At the second level of the bill of material (BOM) there is a material module I that is repeatedly exploded, since material module I belongs to the parent material module C, and also belongs to the parent material module E. Finally, the system drills down to the third level (material modules L, M, N, and O). At the third level of the bill of material (BOM) there are material modules L and M that are repeatedly exploded, as both L and M belong to the parent material module I, which is one of the sub-components of parent material modules C and E.

After prototype A is exploded, the system explodes the first level of the bill of material (BOM) of prototype B (material modules C, F, and G), then explodes the second level (material modules H, I, I, and J). At the second level of the bill of material (BOM) there is a material module I that is repeatedly exploded, since material module I belongs to the parent material module C, and also belongs to the parent material module E. Finally, the system drills down the third level (material modules L, M, L, M, and P). At the third level of the bill of material (BOM) there are material modules L and M that are repeatedly exploded, as both L and M belong to the parent material module I, which is one of the sub-components of parent material modules C and E.

FIG. 6 is an exploded view of bills of material (BOM) according to the disclosed invention that illustrates the method of exploding bills of material (BOM) as follows:

The exploding method of the invention: first, the system explodes all bills of material (BOM) of respective prototypes (prototype A and B, for example), then it combines and explodes the first level of the bills of material (BOM) of both prototypes A and B (material modules C, D, E, F, and G). After the first level is exploded, the system drills down to the second level to combine and explode the bills of material (BOM) of both prototypes A and B (material modules H, I, J, and K). After the second level is exploded, the system drills down to the third level to combine and explode the bills of material (BOM) of both prototypes A and B (material modules L, M, N, O, and P).

Therefore, the method of exploding bills of material (BOM) consists of the following steps: first, explode all bills of material (BOM) of respective prototypes, then stratify all levels of the bills of material (BOM) to assemble features of the respective prototypes, finally, Combine and explode components or parts at each level from all integrated bills of material (BOM).

This method of exploding can greatly reduce the burden to system resources, enhance efficiency, and enable material management and distribution more effectively.

In sum, the conventional method of exploding bills of material (BOM) requires repeatedly exploding material items to match the tree structure of bills of material (BOM). Take material module M as an example. This module has been exploded four times, which heavily occupies the hardware space and wastes time for exploding. Therefore, the disclosed invention utilizes a combination of methods to explode bills of material (BOM), and achieves the following advantages:

1) each material is exploded once to save time for exploding bills of material (BOM);

2) common materials of respective prototypes are easy to be understood;

3) it saves resources of the information system;

4) it reduces the time needed for searching material modules (prototypes only need to be exploded once, so it is not necessary to search various prototypes one-by-one);

5) it is not necessary to have duplicated storage, which can save memory space.

An invention in the form of a method for managing decentralized production and centralized material distribution is disclosed herein. These and other variations, which will be understood by those skilled in the art, are within the intended scope of the invention as claimed below. As previously stated, detailed embodiments of the invention are disclosed herein; however, it is to be understood that the disclosed embodiments are merely exemplary of the invention that may be embodied in various forms.

What is claimed is:

1. A management method for decentralized productions and centralized materials distribution relates to a method that employs to proceed the operation of materials distribution to pre-defined facilities for productions through an Enterprise Resource Planning (ERP) server of an enterprise end on the material management system in the manufacturing industry. The Enterprise Resource Planning (ERP) server is linked to an information intermediary through a network backbone for transferring updated information to a supplier end to complete timely material delivery. The disclosed method at least includes the following steps:
Receiving at least one bill of material (BOM) through the Enterprise Resource Planning (ERP) server;
Integrating the bill of material (BOM) through the Enterprise Resource Planning (ERP) server;
Distributing materials to specified facilities through the Enterprise Resource Planning (ERP) server;
Purchasing materials through the material requirements planning server;
Transferring data to the supplier through a specified data transmission format and method; and
Delivering materials as contracted by the supplier.

2. The invention as recited in claim 1, wherein the specified facilities are categorized based on production requirements of different product prototypes to execute work orders received by the enterprise end.

3. The invention as recited in claim 1, wherein a network backbone is to link up the enterprise end, the suppliers and the information intermediary to proceed data transmission.

4. The invention as recited in claim 1, wherein the steps of integrating the bill of material (BOM) through the Enterprise Resource Planning (ERP) server relate to a method of exploding bills of material (BOM), which method further includes the following steps,
Exploding all bills of material (BOM) of respective prototypes,
Stratifying all the bills of material (BOM), according to assemble features of respective prototypes.
Combining and exploding components or parts at each level from all integrated bills of material (BOM).

5. The invention as recited in claim 1, wherein the operation of distributing materials to specified facilities will be processed after at least one bill of material (BOM) is analyzed and categorized by the Enterprise Resource Planning (ERP) server.

6. The invention as recited in claim 5, wherein specified facilities at least comprise: a specific materials facility, a common materials facility, and a obsolescent stock facility.

7. The invention as recited in claim 6, wherein the specific materials facility is to utilize particular materials for productions, and is manufacturing corresponding specified components or parts needed

8. The invention as recited in claim 7, wherein the specific materials relate to particular components or parts needed for respective prototypes, among which there are no components and parts overlapped in common.

9. The invention as recited in claim 6, wherein the common materials facility is to manage general materials for distributions and deliver common components or parts to required factories/manufactories.

10. The invention as recited in claim 9, wherein the common materials relate to general components or parts needed at least for two prototypes and above, and are evaluated by pre-set column through the Enterprise Resource Planning (ERP) server.

11. The invention as recited in claim 6, wherein the obsolescent stock facility is to manage materials of out-of-date, and to centrally process claim to a buyer who had placed the order.

12. The invention as recited in claim 11, wherein those obsolescent stocks relate to materials at the expiry of the life cycle, and are disposed of according to the enterprise rules.

13. The invention as recited in claim 1, wherein a specified data transmission format and method further includes the following steps,
establishing a data on an enterprise end;
transferring the data to an information intermediary through a network backbone by the enterprise end;
transferring the data to a destination through a global information network by the information intermediary; and
receiving/sending information at the destination by using a browser from the supplier.

14. The invention as recited in claim 1, wherein the step that the enterprise end transfers data to the information intermediary further transfers data format through a data transfer split.

15. The invention as recited in claim 1, wherein the data transfer split is utilizing the configure to order (CTO) concept to complete data transmission on the network with customized fields and formats established based on different requirements of suppliers.

16. The invention as recited in claim 13, wherein the destination end relates to a platform provided by the information intermediary to store data from the supplier end and from the enterprise end.

17. The invention as recited in claim 1, wherein the material requirements planning server is provided by Enterprise Resource Planning (ERP) server to determine capability of product orders by a buyer/client, and place purchase order to the supplier based on determined capability for purchasing.
